(19) United States
(12) Patent Application Publication
(10) Pub. No.: US 2023/0319937 A1
(43) Pub. Date: Oct. 5, 2023

(54) Methods and Apparatuses for a Remote UE to Communicate with Via a Relay UE

(71) Applicant: Telefonaktiebolaget LM Ericsson (PUBL), Stockholm (SE)

(72) Inventors: Min Wang, LULEÅ (SE); Zhang Zhang, BEIJING (CN)

(21) Appl. No.: 18/040,027

(22) PCT Filed: Jul. 20, 2021
(86) PCT No.: PCT/EP2021/070264

§ 371 Date: Jan. 31, 2023

(30) Foreign Application Priority Data
Aug. 5, 2020 (WO) PCT/CN2020/107090

(51) Int. Cl. H04W 76/19; H04W 76/14

(52) U.S. Cl. CPC H04W 76/19; H04W 76/14; H04W 88/04

(57) ABSTRACT

Methods and apparatuses, i.e. a remote UE as a first wireless wireless device and a relay UE as a second wireless device, are disclosed. The first wireless device is communicating with a cellular communication network via a second wireless device operating as a relay UE. The method comprises receiving (702) radio link information from the relay UE, wherein the radio link information relates to a cellular radio link between the relay UE and a base station in the cellular communication network, forwarding (704) the received radio link information to an upper layer of the first wireless device, and analysing (706), in the upper layer, the received radio link information to determine a status of the cellular radio link.

### TECHNICAL FIELD

Embodiments of the disclosure generally relate to communication, and, more particularly, to methods of operating wireless devices, wireless devices configured to performs the methods and to a computer program and a computer program product configured, when run on a computer to carry out such methods.

### BACKGROUND

This section introduces aspects that may facilitate better understanding of the present disclosure. Accordingly, the statements of this section are to be read in this light and are not to be understood as admissions about what is in the prior art or what is not in the prior art.

This disclosure relates to communication networks, and in particular a scenario in which a user equipment (UE) is operating as a relay UE between another UE (referred to as a ‘remote UE’) and a radio access network (RAN). The connection between the remote UE and the relay UE can be according to 5th Generation (5G) techniques, in which case the connection is known as ‘sidelink’ and is specified in the Third Generation Partnership Project (3GPP) Release 16 standards. Alternatively, other communication technologies can be used, such as WiFi or Bluetooth.

Thus, a remote UE can be connected to a RAN via a Relay UE (e.g. a Proximity-based Services (ProSe) UE-to-Network Relay). The relay UE can be a dedicated relay device, or a typical UE that can selectively operate as a relay UE. The interface between the Remote UE and the Relay UE is known as a PC5 interface, and the interface between the Relay UE and the RAN is the Uu interface.

The Relay UE entity provides the functionality to support connectivity to the network for Remote UEs. It can be used for both public safety services and commercial services (e.g. an interactive service).

A UE is considered to be a Remote UE for a certain relay UE if it has successfully established a PC5 link to this Relay UE. A Remote UE can be located within RAN coverage or outside of RAN coverage. The Relay UE shall relay unicast traffic (uplink (UL) and downlink (DL)) between the Remote UE and the network. The Relay UE shall provide generic function that can relay any Internet Protocol (IP) traffic. A Relay UE can be Layer 3 (L3) based or Layer 2 (L2) based.

FIG. 1 illustrates the architecture for the 5th generation (5G) system. As shown, the 5G system comprises a user equipment (UE), a (radio) access network ((R)AN), a user plane function (UPF), a data network (DN), an authentication server function (AUSF), an access and mobility management function (AMF), a session management function (SMF), a service communication proxy (SCP), a network slice selection function (NSSF), a network exposure function (NEF), a network repository function (NRF), a policy control function (PCF), a unified data management (UDM) and an application function (AF).

The 5G architecture is defined as service-based and the interaction between network functions (NFs) is represented in two ways. One way is a service-based representation, where NFs (e.g. AMF) within the control plane enables other authorized NFs to access their services. This representation also includes point-to-point reference points where necessary. The other way is a reference point representation, which shows the interaction existing between the NF services in the NFs described by point-to-point reference point (e.g. N11) between any two NFs (e.g. AMF and SMF).

The NEF supports external exposure of capabilities of NFs. External exposure can be categorized as monitoring capability, provisioning capability, policy/charging capability and analytics reporting capability. The monitoring capability is for monitoring of specific event for UE in the 5G system and making such monitoring events information available for external exposure via the NEF. The provisioning capability is for allowing an external party to provision of information which can be used for the UE in the 5G system. The policy/charging capability is for handling quality of service (QoS) and charging policy for the UE based on the request from an external party. The analytics reporting capability is for allowing an external party to fetch or subscribe/unsubscribe to analytics information generated by the 5G system.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In the upcoming 3GPP Release 17 (Rel-17) Study Item (SI) on New Radio (NR) sidelink relay (3GPP submission RP-193253), several objectives will be studied. One of these objectives is to consider the impact on the user plane protocol stack and the control plane procedure, e.g. connection management of relayed connection.

In a 4th Generation (4G) network and 5G networks a radio link monitoring (RLM) procedure is provided the enable the UE to detect if there is a radio link failure (RLF) on the cellular link to the network. If a RLF is detected, the UE may need to perform a recovery procedure to re-establish a radio connection.

In a L2 UE-to-network relay scenario, an RLF event may occur in either the sidelink between the remote UE and the relay UE, or in the cellular link (Uu) between the relay UE and the base station. In case an RLF is triggered for the sidelink, the remote UE can select another relay UE to mitigate potential service interruptions. In case the cellular link has been experiencing poor radio link quality, a New Radio (NR) Physical (PHY) layer (configured at the relay UE) would trigger out of sync/in sync indicators consistently, however, the NR PHY layer will not be able to send the indicators upward to NR radio resource control (RRC) layer since the NR RRC layer is configured at the remote UE. In this case, the RLF of cellular link will not be able to be declared in time. Therefore, an interruption would be imposed on the transmissions between the remote UE and the RAN, which may be not acceptable to the remote UE especially when data with critical latency requirement is being transmitted.

Therefore, it is an aim provide solutions to avoid service interruption caused by RLF on the cellular link.

According to a first aspect of the disclosure, there is provided a method of operating a first wireless device. The first wireless device is communicating with a cellular communication network via a second wireless device operating as a relay UE. The method comprises receiving radio link information from the relay UE, wherein the radio link information relates to a cellular radio link between the relay UE and a base station in the cellular communication network, forwarding the received radio link information to an upper layer of the first wireless device, and analysing, in the upper layer, the received radio link information to determine a status of the cellular radio link.

According to a second aspect of the present disclosure, there is provided a method of operating a second wireless device. The second wireless device is enabling communication between a cellular communication network and a first wireless device operating as a remote UE. The method comprises transmitting radio link information to the remote UE, wherein the radio link information relates to a cellular radio link between the second wireless device and a base station in the cellular communication network.

According to a third aspect, there is provided a computer program product comprising a computer readable medium having computer readable code embodied therein, the computer readable code being configured such that, on execution by a suitable computer or processor, the computer or processor is caused to perform the method according to the first aspect, the second aspect, or any embodiment thereof.

According to a fourth aspect of the present disclosure, there is provided a first wireless device, wherein the first wireless device is communicating with a cellular communication network via a second wireless device operating as a relay UE. The first wireless device comprises at least one processor, and at least one memory. The at least one memory contains instructions executable by the at least one processor, whereby the first wireless device is operative to receive radio link information from the relay UE, wherein the radio link information relates to a cellular radio link between the relay UE and a base station in the cellular communication network, forward the received radio link information to an upper layer of the first wireless device, and analyse, in the upper layer, the received radio link information to determine a status of the cellular radio link.

According to a fifth aspect of the present disclosure, there is provided a second wireless device. The second wireless device is enabling communication between a cellular communication network and a first wireless device operating as a remote UE. The second wireless device comprises at least one processor, and at least one memory. The at least one memory contains instructions executable by the at least one processor, whereby the second wireless device is operative to transmit radio link information to the remote UE, wherein the radio link information relates to a cellular radio link between the second wireless device and a base station in the cellular communication network.

According to a sixth aspect of the present disclosure, there is provided a first wireless device, wherein the first wireless device is communicating with a cellular communication network via a second wireless device operating as a relay UE. The first wireless device is configured to receive radio link information from the relay UE, wherein the radio link information relates to a cellular radio link between the relay UE and a base station in the cellular communication network, forward the received radio link information to an upper layer of the first wireless device, and analyse, in the upper layer, the received radio link information to determine a status of the cellular radio link.

According to a seventh aspect of the present disclosure, there is provided a second wireless device. The second wireless device is enabling communication between a cellular communication network and a first wireless device operating as a remote UE. The second wireless device is configured to transmit radio link information to the remote UE, wherein the radio link information relates to a cellular radio link between the second wireless device and a base station in the cellular communication network.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating the architecture for the 5G system;

FIG. 2 shows an example of a protocol stack for user plane transport;

FIG. 3 shows an example of a protocol stack of a NAS connection;

FIG. 4 show examples in which an RLF is triggered;

FIG. 5 shows another example in which an RLF is triggered;

FIG. 6 shows a number of examples by which an upper layer of a wireless device may receive radio link information;

FIG. 7 shows a flowchart illustrating a method of operating a first wireless device;

FIG. 8 shows a flowchart illustrating a method of operating a second wireless device;

FIG. 9 shows an example first wireless device;

FIG. 10 shows an example second wireless device;

FIG. 11 shows an example first wireless device;

FIG. 12 shows an example second wireless device; and

FIG. 13 shows an exemplary UE according to various embodiments.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

A L2 UE-to-Network Relay UE (referred to herein as a “relay UE”) can provide forwarding functionality that can relay traffic over a PC5 link, and can also provide the functionality to support connectivity to the 5G System (5GS) for one or more remote UEs. A UE can be considered to be a remote UE if the UE has successfully established a PC5 link to the relay UE. A remote UE can be located within NG-RAN coverage, or outside of NG-RAN coverage.

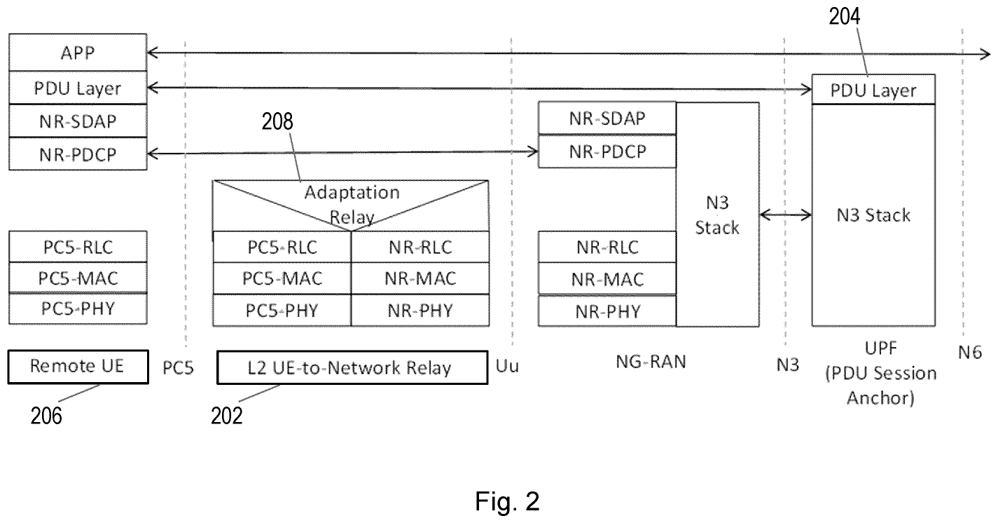

FIG. 2 shows an example of a protocol stack for user plane transport, related to a Protocol Data Unit (PDU) Session, including a relay UE 202. The PDU layer 204 corresponds to the PDU carried between the remote UE 206 and the Data Network (DN) over the PDU session. The two endpoints of the Packet Data Convergence Protocol (PDCP) link are the remote UE 206 and the gNB. The relay function is performed below the PDCP link. As a result, data security between the remote UE 206 and the gNB is ensured, without exposing raw data at the relay UE 204.

The adaptation relay layer 208 within the relay UE can differentiate between signalling radio bearers (SRBs) and data radio bearers (DRBs) for a particular remote UE 206. The adaption relay layer 208 is also responsible for mapping PC5 traffic to one or more DRBs of the Uu. The definition of the adaptation relay layer 208 is under the responsibility of RAN WG2.

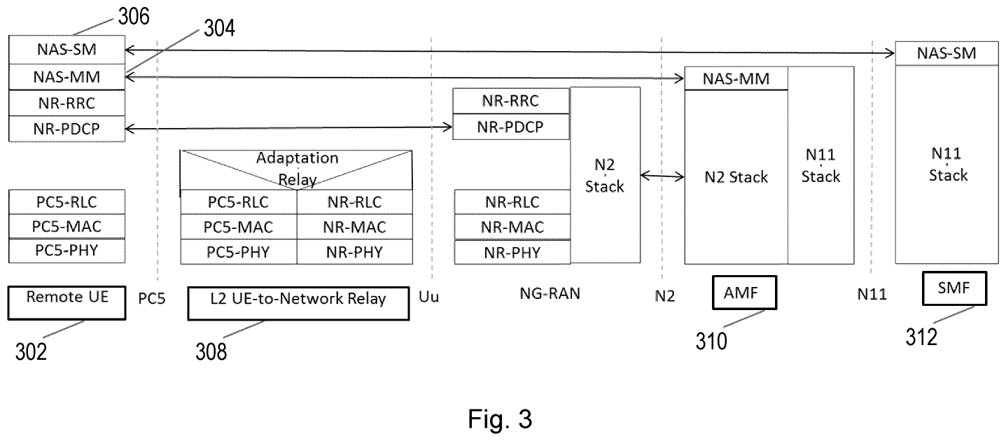

FIG. 3 shows an example of a protocol stack of a Non-Access Stratum (NAS) connection for a remote UE 302 to the NAS-MM 304 and NAS-SM 306 components. The NAS messages are transparently transferred between the remote UE 302 and 5G-AN over the relay UE 308 using:
PDCP end-to-end connection, where the role of the relay UE 308 is to relay the PDUs over the signalling radio bearer without any modifications.
N2 connection between the 5G-AN and AMF 310 over N2.
N3 connection AMF 310 and SMF 312 over N11.

The role of the UE-to-Network Relay UE is to relay the PDUs from the signalling radio bearer without any modifications.

As described in 3GPP TR 37.985 V2.0.0, sidelink (SL) RLM/RLF is supported for unicast NR sidelink communication. Upon radio link (RL) RLF declaration, the UE releases the PC5 RRC connection and sends an indication to an upper layer (for example, an NR RRC layer). For RRC_CONNECTED UEs, the UE also informs the network (via the sidelink) of UE information upon RLF being detected. Furthermore, as described in 3GPP TR 38.885 V16.0.0, for RLC AM in SL unicast, RLF declaration is triggered by an indication from RLC that the maximum number of retransmissions has been reached. The access stratum (AS)-level link status (for example, failure) should then be informed to upper layers (for example, an NR RRC layer). No RLM design specific to groupcast, different than the RLM procedure for unicast is considered, and there is no need for RLM/RLF declarations among group members for groupcast.

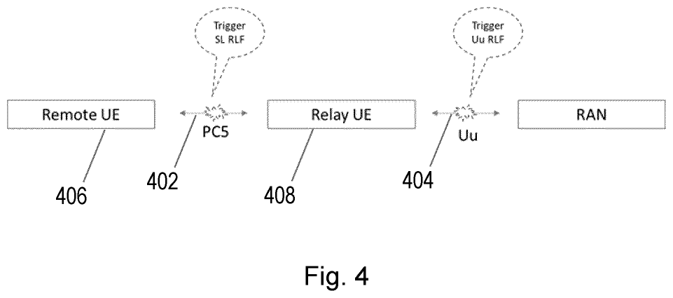

As shown in FIG. 4, for a L2 UE-to-network relay scenario, an RLF event may be triggered in either the sidelink 402 or the cellular link (Uu) 404. In the case that an RLF is triggered for the sidelink 402, the remote UE 406 can select another relay UE 408 to mitigate potential service interruptions. In another example, in which the cellular link 404 has been experiencing bad radio link quality, the NR PHY layer (configured at the relay UE 408) may trigger out of sync/in sync indicators consistently. However, the NR PHY layer will not be able to send the indicators upward to NR RRC layer, as the NR RRC layer is configured at the remote UE 406. Therefore, the RLF of cellular link will not be declared in time to the NR RRC layer.

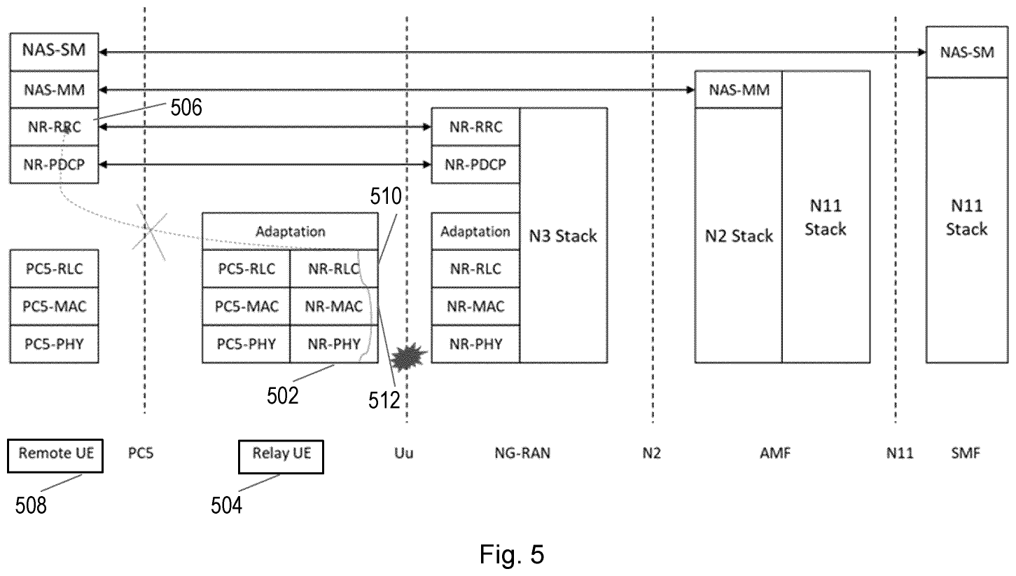

This example is also illustrated in FIG. 5. In this example, the NR PHY layer 502 (configured at the relay UE 504) may trigger out of sync/in sync indicators consistently. However, the NR PHY layer 504 will not be able to send the indicators upward to NR RRC layer 506, as the NR RRC layer 506 is configured at the remote UE 508.

Similarly, if there is an RLC failure (for example, a maximum number of RLC retransmission attempts is reached in UL) or RACH failure (for example, a maximum number of RACG transmission attempts is reached) on the cellular link, the NR lower layers (for example, the NR-RLC layer 510, or the NR-Medium Access Control (MAC) layer 512) at the relay UE 504 cannot inform NR-RRC layer 506 at the remote UE 508 of these failures. This will further affect RLF procedure such that RLF on the cellular link may not be able to be declared in time to the NR RRC layer 506.

In such cases, an interruption would be imposed on the transmissions between the remote UE 508 and the RAN. This may be not acceptable to the remote UE 508, especially in the case when data with a critical latency requirement is being transmitted.

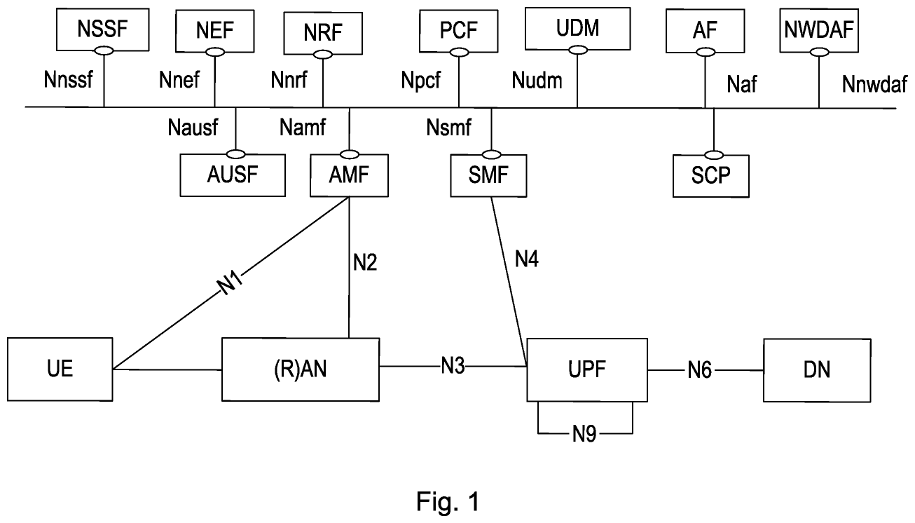

The present disclosure proposes an improved solution for operating a wireless device as a remote UE, such that in an upper layer of the wireless device, radio link information may be received, and may further be analysed to determine a status of the cellular radio link between a relay UE and a base station. As an exemplary example, the solution may be applied to the communication system shown in FIG. 1.

Note that within the context of this disclosure, the term wireless device (or UE) used herein may also be referred to as, for example, terminal device, access terminal, mobile station, mobile unit, subscriber station, or the like. It may refer to any (a stationary or mobile) end device that can access a wireless communication network and receive services therefrom. By way of example and not limitation, the UE may include a portable computer, an image capture terminal device such as a digital camera, a gaming terminal device, a music storage and playback appliance, a mobile phone, a cellular phone, a smart phone, a tablet, a wearable device, a personal digital assistant (PDA), an integrated or embedded wireless card, an externally plugged in wireless card, or the like.

In an Internet of things (IoT) scenario, a wireless device (or UE) may represent a machine or other device that performs monitoring and/or measurements, and transmits the results of such monitoring and/or measurements to another terminal device (or UE) and/or a network equipment. In this case, the terminal device (or UE) may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

As used herein, the term “communication system” refers to a system following any suitable communication standards, such as the first generation (1G), 2G, 2.5G, 2.75G, 3G, 4G, 4.5G, 5G communication protocols, and/or any other protocols either currently known or to be developed in the future. Furthermore, the communications between a wireless device and a network node (or network entity) in the communication system may be performed according to any suitable generation communication protocols, including, but not limited to, 1G, 2G, 2.5G, 2.75G, 3G, 4G, 4.5G, 5G communication protocols, and/or any other protocols either currently known or to be developed in the future. In addition, the specific terms used herein do not limit the present disclosure only to the communication system related to the specific terms, which however can be more generally applied to other communication systems.

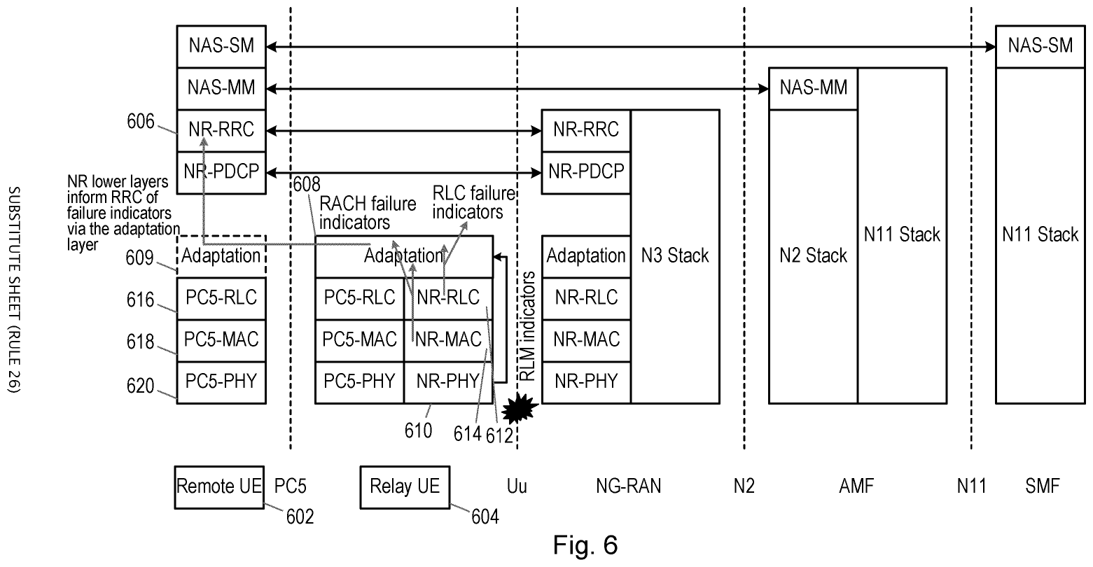

FIG. 6 shows a number of examples by which an upper layer of a first wireless device that is communicating with a cellular communication network via a second wireless device operating as a relay UE may receive radio link information. The first wireless device is remote UE 602. It will be appreciated that the remote UE 602 may further analyse the received radio link information in order to determine a status of a cellular radio link.

It will be appreciated that, the embodiments described below are described in the context of New Radio (NR) (in other words, embodiments in which the relay UE 604 is deployed in an NR cell). However, it will be appreciated that the embodiments provided below are not limited to a NR context, are applicable to any L2 based UE to network relay (for example, a Long Term Evolution (LTE) L2 UE to network relay). Additionally, the connection between the remote UE 602 and the relay UE 604 referred to in the embodiments provided below is not limited to a sidelink, and it will be appreciated that any short range communication technology (for example, WiFi or Bluetooth) may be used.

In some embodiments, for a L2 based UE to network relay scenario, the outcome results of RLM on the cellular link at the relay UE 604 may be informed to a NR upper layer (for example, the NR RRC layer 606, or a PDCP or SDAP layer) at the remote UE 602 via the adaptation layer 608 in the relay UE 604 and an adaptation layer 609 in the remote UE. In these embodiments, it will be appreciated that the adaptation layer is required to be configured at both the remote UE 602 and the relay UE 604. Embodiments relating to this handling procedure at the adaptation layer 608, 609 are presented below. As is known, the adaptation layer 608 in a relay UE 604 is used to separate or distinguish traffic that is to/from the remote UE 602 and traffic that is for the relay UE 604 (e.g. data traffic for a user of the relay UE 604). The adaptation layer 608 can be also used to separate or distinguish traffic between different relay UEs such as the relay UE 604. In some embodiments, the handling procedure at the adaptation layer 608 in the relay UE 604 may comprise the handling of out of sync and/or in sync indicators. For example, in some embodiments, the downlink radio channel quality of the cellular link may be monitored at a lower layer (for example, a NR PHY layer 610) at the relay UE 604. The NR PHY layer 610 may then periodically generate an indication for out-of-sync, or for in-sync, appropriately. This generated indication may then be sent to a NR upper layer at the remote UE 602 (for example, the NR RRC layer 606) via the adaptation layer 608, 609 that has been configured at both the remote UE 602, and at the relay UE 604. In some embodiments, at the relay UE 604, a control PDU may generated at the adaptation layer 608 for forwarding the out-of-sync and/or in-sync indicators to the remote UE 602. The control PDU may be transmitted to the remote UE 602 via the sidelink. At the remote UE 602, the out-of-sync indicators and/or the in-sync indicators may then be forwarded by the adaptation layer 609 upwards to the NR RRC layer 606, or to another NR upper layer. This NR upper layer at the remote UE 602 may then evaluate if a radio link failure has been triggered based on the received in-sync and out-of-sync indicators. When the consecutively received out-of-sync indications are beyond a predetermined counter (e.g. counter N310), a timer (e.g. timer T310) is started by the remote UE 602. The radio link is considered to be recovered if the NR upper layer (for example, the NR RRC layer 606) consecutively receives in-sync indications (e.g. N311 in-sync indications) from the NR lower layer (for example, the NR PHY layer 610) while the timer is running. Alternatively, if the timer expires, a radio link failure for the cellular link is declared by the remote UE 602.

In some embodiments, the handling procedure at the adaptation layer 608 in the relay UE 604 may comprise the handling of RLC failure. For example, in some embodiments, the relay UE 604 may reach a maximum number of RLC retransmissions in UL on the cellular link. In some embodiments, a Random Access Channel (RACH) failure indicator may then be generated at the NR RLC layer 612. In some embodiments, at the relay UE 604, a control PDU may be generated at the adaptation layer 608 for forwarding a RLC failure indicator to the remote UE 602. The control PDU may be transmitted to the remote UE 602 via the sidelink. At the remote UE 602, the RLC failure indicator may then be forwarded by the adaptation layer 609 upwards to the NR RRC layer 606.

In some embodiments, the handling procedure at the adaptation layer 608 may comprise the handling of RACH failure. For example, in some embodiments, the relay UE 604 may reach a maximum number of RACH transmission attempts on the cellular link. In some embodiments, a RACH failure indicator may then be generated at the NR MAC layer 614. In some embodiments, at the relay UE 604, a control PDU may be generated at the adaptation layer 608 for forwarding a RACH failure indicator to the remote UE 602. The control PDU may be transmitted to the remote UE 602 via the sidelink. At the remote UE 602, the RACH failure indicator may then be forwarded by the adaptation layer 608 upwards to the NR RRC layer 606.

In some alternative embodiments, RLM results, or failure indicators of the cellular link, generated by NR lower layers (for example, the NR PHY layer 606, the NR RLC layer 612, or the NR MAC layer 614) at the relay UE 604 may be forwarded or reported to an NR upper layer (for example, the NR RRC layer 606) at the remote UE 602 via a layer in the PC5 interface (for example, a PC5-RLC layer 616, or a PC5-MAC layer 618) rather than via the adaptation layer 608. It will be appreciated that, in these embodiments, the adaptation layer 609 may not need to be configured for the remote UE 602.

In some embodiments, where a report relating to RLM results, or failure indicators of the cellular link is sent via the PC5-MAC layer 618, a PC5 MAC Control Element (CE) may be used to carry the report. In some embodiments, the PC5 MAC CE may be transmitted by the relay UE 604 to one or more remote UEs 602 via a sidelink transmission. It will be appreciated that this transmission may occur in a unicast, in a groupcast, or in a broadcast fashion. In some embodiments, the transmission may also indicate control information. It will be appreciated that the PC5 MAC CE differs from the existing MAC CE, as the existing MAC CE is used to convey control information between a UE and a gNB. It will also be appreciated that the term PC5 MAC CE may be interchangeably referred to as a control command, or as a control order. In some embodiments, in which the report is received at a PC5 layer at the remote UE 602, the remote UE 602 may send the report upwards to the NR RRC layer 606.

In some embodiments, the detection of radio link failure (for example, as discussed in 3GPP TS 38.331 v16.0.0 clause 5.3.10.3) may be performed at a NR lower layer at the relay UE 604 (for example, the, NR RLC 612 layer, or the NR MAC 614 layer), rather than at the NR RRC layer 606 at the remote UE. For example, whether or not an RLF event can be declared for the cellular link may be determined by a NR lower layer at the relay UE 604. In these embodiments, the RLF indicator can be reported by a NR lower layer at the relay UE 604 to a NR upper layer at the remote UE 602 (for example, the NR RRC layer 606) via the adaptation layer 608, 609, or a PC5-layer, in a similar manner to those described above.

In some embodiments, in an attempt to mitigate potential service interruption caused by RLF on the cellular link, a NR upper layer (for example, the NR RRC layer 606) at the remote UE 602 may be informed of a first message indicating that an RLF may be triggered in the future on the cellular link. In some embodiments, the transmission of the first message may be triggered based on RLM results at the NR lower layer (for example, the NR RLC layer 612, or the NR MAC layer 614, or the NR PHY layer 610) at the relay UE 604. Upon receipt of the first message, the remote UE 602 may take action to reselect another relay UE 604 prior to the occurrence of an RLF event. In this way, the remote UE 602 can mitigate the potential service interruptions resulting from a RLF. Following receipt of this first message, in an example in which the remote UE 602 does not reselect another relay UE 604, a NR upper layer (for example, the NR RRC layer 606) at the remote UE 602 may be informed of a second message indicating that an RLF is being triggered on the cellular link. In some examples, in which the RLF on the cellular link is recovered by the relay UE 604, a NR lower layer at the relay UE 604 may inform the NR upper layer at the remote UE 602 of a third message, indicating that the RLF has been recovered successfully. In other examples, in which the RLF on the cellular link is not recovered by the relay UE 604, a NR lower layer at the relay UE 604 may inform a NR upper layer at the remote UE 602 of a third message, indicating that the RLF has not been recovered successfully. It will be appreciated that, in a similar manner as described in the aforementioned embodiments, the RLF indicator may be reported by a NR lower layer at the relay UE 604 to a NR upper layer (for example, the NR RRC layer 606) at the remote UE 602 via the adaptation layer 609, or via a PC5-layer.

It will be appreciated that, in a L2 based UE to network relay scenario, besides serving the remote UE 602 as a relay UE 604, the relay UE 604 may also have its own RRC connection towards its serving gNB. It will also be appreciated that, in these circumstances, an RLF event may be declared for the relay UE's 604 own cellular connection. Therefore, in some embodiments, any message or indicator indicating a failure event of the cellular link can be signalled by the relay UE 604 to the remote UE 602 via a PC5-RRC signalling. In some embodiments, if there is no PC5 RRC connection between the relay UE 604 and the remote UE 602 available, the relay UE 604 may be triggered to establish a PC5 RRC connection towards the remote UE 602 upon detection of a failure event for the cellular link. Following this establishment, the failure event for the cellular link may be sent to the remote UE 602 via the PC5 RRC connection. As noted above, it will be appreciated that, in these embodiments, the adaptation layer 609 may not need to be configured for the remote UE 602.

It will be appreciated that, in some embodiments, more than one remote UE 602 may be linked to the relay UE 604. In such embodiments, the aforementioned results or indicators of failure events may be sent in unicast manner to each of the remote UEs 602 linked to the relay UE 604, or alternatively, in groupcast manner to all of the remote UEs 602 linked to the relay UE 604. Alternatively, the results or indicators of failure events may only be sent to one of the remote UEs 602 linked to the relay UE 604. In this example the remote UE 602 that receives the results or indicators of failure events may have been selected to execute RLF handling of the cellular link of the relay UE 604.

In some embodiments, the gNB may configure which remote UE 604 (that is linked to the relay UE 602) should execute the RLF handling. In some embodiments, this configuration may be based on which remote UE 602 has good PC5 link quality to the relay UE 604. Alternatively, in some embodiments, the relay UE 604 may select which remote UE 602 should execute the RLF handling.

In some embodiments (in accordance with any of the aforementioned embodiments), upon reception of the measurements, results or indicators of failure events on the cellular link, the NR upper layer (for example, the NR RRC layer 606) at the remote UE 602 may decide if an RLF event should be declared for the cellular link. It will be appreciated that, upon detection of an RLF event for the cellular link, the remote UE 602 may perform one or more of the following actions. In some embodiments, the remote UE 602 may release the PC5 connection with the relay UE 604 (where the PC5 connection with the relay UE 604 exists), and may additionally inform the relay UE 604 that the PC5 connection should be released. The remote UE 602 may also indicate the cause of the releasing (for example, the RLF event for the cellular link).

Additionally or alternatively, in some embodiments, the remote UE 602 may inform the relay UE 604 that the NR lower layers (e.g. any or all of the NR RLC layer 612, NR MAC layer 614, and NR PHY layer 610) should be released. The remote UE 602 may also indicate the cause of the releasing, (for example, the RLF event for the cellular link). In some embodiments, the remote UE 602 may send an indicator to the relay UE 604 to release NR lower layers. The indicator may be sent via the adaptation layer 608, a PC5-layer, or via a PC5-RRC signalling message.

Additionally or alternatively, the remote UE 602 may maintain a RRC connection towards the cellular communication network, and/or maintain radio bearers towards the cellular communication network, and/or maintain Packet Data Convergence Protocol, PDCP, entities towards the cellular communication network.

In some embodiments, the remote UE 602 may also be triggered to execute a discovery procedure to find another relay UE 604, in order to reduce the potential service interruption caused by the RLF. If another connection is established with another relay UE 604, the adaptation layer 608 and the PC5 lower layers including PC5 RLC layer 616, PC5 MAC layer 618, and PC5 PHY layer 620 will be re-established at the newly selected relay UE 604. In some embodiments, the remote UE 602 may indicate the serving cell ID where the RLF is declared in the PC5 link establishment request. In some embodiments, the relay UE 604 may indicate in the link establishment response whether it is served/in the coverage of that cell (in which the RLF is declared). In some embodiments, the remote UE 602 may prioritize connecting to a relay UE 604 serving and/or in the coverage of the same cell, to facilitate a faster recovery of its Uu RRC connection. In some embodiments, the remote UE 602 may trigger a procedure at the application layer to mitigate the service interruption (for example, the procedure defined in the 3GPP TS 23.280 v17.3.0, Annex B.1).

It will be appreciated that, in some embodiments, a relay UE 604 may be configured with multiple cellular connections (for example, via dual connectivity or carrier aggregation). In these embodiments, the relay UE 604 may indicate RLM results or a failure indicator of any of the multiple cellular links/connections to a remote UE 602 according to any of the aforementioned embodiments. In some embodiments, the indicated information may also contain a failure cause and/or a link/connection ID indicating the connection/link where the RLM results or the failures have been triggered. In some embodiments, in which there are multiple connections/links in which failures have been detected, a bitmap field may be included the indicated information, wherein the bitmap contains multiple bits each indicating a specific connection/link. It will be appreciated that, upon reception of the RLM results or the indicators, the remote UE 602 may perform any of the actions described above. Additionally, in some embodiments the remote UE 602 may be triggered to switch to a cellular links/connections where no failures have been detected.

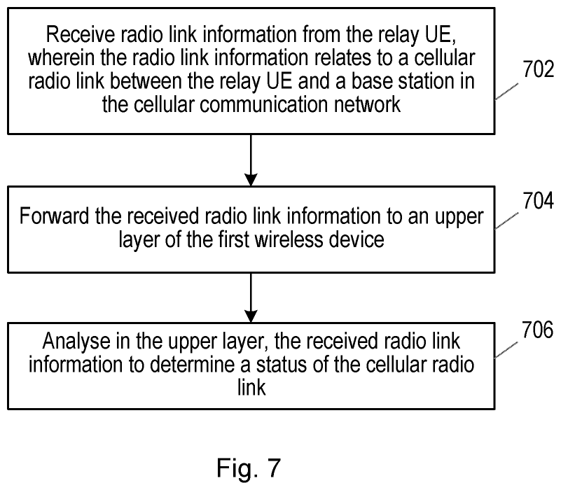

FIG. 7 is a flowchart illustrating a method 700 of operating a first wireless device as a remote UE 602. The first wireless device is communicating with a cellular communication network via a second wireless device operating as a relay UE, according to an embodiment of the disclosure. The method 700 comprises, in a first step 702, receiving radio link information from the relay UE. The radio link information relates to a cellular radio link between the relay UE and a base station in the cellular communication network.

In some embodiments, the step 702 may comprise receiving the radio link information from the relay UE at an adaptation layer of the first wireless device. Alternatively, in some embodiments, the step 702 may comprise receiving the radio link information from the relay UE at a PC5 layer of the first wireless device. In some embodiments, the PC5 layer may comprise one of the following: a PC5-RRC layer, a PC5-MAC layer, and a PC5-RLC layer.

In some embodiments, the radio link information may comprise one or more of: RLM information, a failure indication relating to the cellular radio link, an impending failure indication relating to the cellular radio link, a RLF event indicator, an out of sync indicator, an in sync indicator, a RLC failure indicator, a number of uplink RLC retransmissions on the cellular radio link, a RACH failure indicator, a number of random access transmission attempts on the cellular radio link, an indication of whether a number of random access transmission attempts on the cellular radio link has reached a maximum number of attempts, a radio link identifier, and a failure cause. In some embodiments, the radio link information may relate to a RRC connection of the relay UE to the base station.

In step 704, the method 700 comprises forwarding the received radio link information to an upper layer of the first wireless device. In some embodiments, the upper layer may comprise a radio resource control, RRC, layer.

In step 706, the method 700 comprises, analysing, in the upper layer, the received radio link information to determine a status of the cellular radio link. In some embodiments, the status of the cellular radio link may comprise an indication of whether a failure of the cellular radio link has occurred.

In some embodiments, the method 700 may further comprise the steps of determining an action to perform based on the determined status of the cellular radio link, and performing the action. In some embodiments, the action may comprise one or more of (i) declaring a RLF event for the cellular radio link, (ii) releasing a PC5 connection with the relay UE, (iii) informing the relay UE to release a PC5 connection with the first wireless device, (iv) informing the relay UE to release a RLC layer connection, a MAC layer connection and/or a PHY layer connection towards the cellular communication network, (v) maintaining a RRC connection at the first wireless device towards the cellular communication network, (vi) maintaining radio bearers at the first wireless device towards the cellular communication network, (vii) maintaining PDCP entities at the first wireless device towards the cellular communication network. In some embodiments, the action may further comprise initiating a discovery procedure to identify a further relay UE that a connection may be established with. In some embodiments, the method 700 may further comprise the step of establishing a connection with the further relay UE.

In some embodiments, the relay UE may have a plurality of cellular radio links to the cellular communication network, and the received radio link information may relate to any one or more of the plurality of cellular radio links.

In some embodiments, the wireless device and the relay UE may be connected via LTE or 5G sidelink, or via a short-range communication technology.

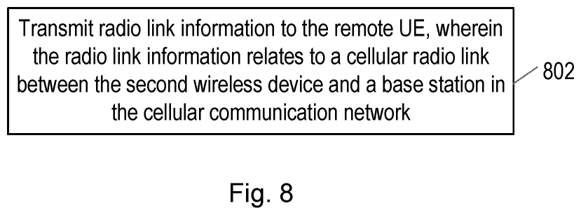

FIG. 8 is a flowchart illustrating another method 800 of operating a second wireless device. In these embodiments the second wireless device is operating as a relay UE. The second wireless device is enabling communication between a cellular communication network and a first wireless device operating as a remote UE, according to an embodiment of the disclosure. The method 800 comprises, in a first step 802, transmitting radio link information to the remote UE. The radio link information relates to a cellular radio link between the second wireless device and a base station in the cellular communication network.

In some embodiments, the radio link information comprises one or more of: RLM information, a failure indication relating to the cellular radio link, an impending failure indication relating to the cellular radio link, a RLF event indicator, an out of sync indicator, an in sync indicator, a RLC failure indicator, a number of uplink RLC retransmissions on the cellular radio link, a RACH failure indicator, a number of random access transmission attempts on the cellular radio link, an indication of whether a number of random access transmission attempts on the cellular radio link has reached a maximum number of attempts, a radio link identifier, and a failure cause. In some embodiments, the radio link information relates to a RRC connection of the relay UE to the base station.

In some embodiments the step of transmitting the radio link information to the remote UE comprises transmitting the radio link information to the remote UE via an adaptation layer of the second wireless device. Alternatively, in some embodiments, the step of transmitting the radio link information to the remote UE comprises transmitting the radio link information to the remote UE via a PC5 layer of the second wireless device. In some embodiments, the PC5 layer comprises one of the following: a PC5-RRC layer, a PC5-MAC layer, and a PC5-RLC layer.

In some embodiments, the method 800 further comprises the step of determining whether a failure of the cellular radio link has occurred, and the radio link information may indicate whether a failure of the cellular radio link has occurred.

In some embodiments, the step of determining may be performed in one of: a RLC layer of the second wireless device, a MAC layer of the second wireless device, and a PHY layer of the second wireless device.

In some embodiments, the second wireless device is enabling communication between the cellular communication network and a plurality of first wireless devices each operating as a remote UE, and the method 800 may further comprise unicasting the radio link information to one or more of the remote UEs.

In some embodiments, the second wireless device is enabling communication between the cellular communication network and a plurality of first wireless devices each operating as a remote UE, and the method 800 may further comprise groupcasting the radio link information to the remote UEs.

In some embodiments, the method 800 may further comprise one or more of the following steps: (i) releasing a PC5 connection with the relay UE, (ii) receiving an instruction from the remote UE to release a PC5 connection with the remote UE, and (iii) receiving an instruction from the remote UE to release a RLC layer, a MAC layer and/or a PHY layer towards the cellular communication network.

In some embodiments, the second wireless device may have a plurality of cellular radio links to the cellular communication network, and the transmitted radio link information may relate to any one or more of the plurality of cellular radio links.

In some embodiments, the second wireless device and the remote UE may be connected via LTE or 5G sidelink, or via a short range communication technology.

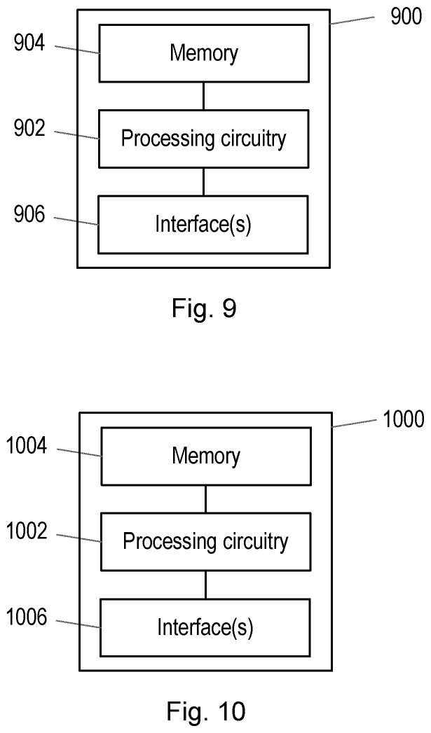

FIG. 9 is a block diagram illustrating an example first wireless device. The first wireless device 900 is for communicating with a cellular communication network via a second wireless device operating as a relay UE. The first wireless device 900 may implement the method 700 according to examples of the present disclosure, for example on receipt of suitable instructions from a computer program. Referring to FIG. 9, the first wireless device 900 comprises a processor or processing circuitry 902, a memory 904 and interfaces 906. The memory 904 may contain instructions executable by the processor 902 such that the first wireless device 900 is operative to conduct some or all of the steps of the method 700. The instructions may also include instructions for executing one or more telecommunications and/or data communications protocols. The instructions may be stored in the form of the computer program 950. In some examples, the processor or processing circuitry 902 may include one or more microprocessors or microcontrollers, as well as other digital hardware, which may include digital signal processors (DSPs), special-purpose digital logic, etc. The processor or processing circuitry 902 may be implemented by any type of integrated circuit, such as an Application Specific Integrated Circuit (ASIC), Field Programmable Gate Array (FPGA) etc. The memory 904 may include one or several types of memory suitable for the processor, such as read-only memory (ROM), random-access memory, cache memory, flash memory devices, optical storage devices, solid state disk, hard disk drive etc.

FIG. 10 is a block diagram illustrating an exemplary second wireless device. The second wireless device 1000 is for enabling communication between a cellular communication network and a first wireless device operating as a remote UE. Thus, the second wireless device 1000 is operating as a relay UE and may implement the method 800 according to examples of the present disclosure, for example on receipt of suitable instructions from a computer program. Referring to FIG. 10, the second wireless device 1000 comprises a processor or processing circuitry 1002, a memory 1004 and interfaces 1006. The memory 1004 may contain instructions executable by the processor 1002 such that the second wireless device 1000 is operative to conduct some or all of the steps of the method 800. The instructions may also include instructions for executing one or more telecommunications and/or data communications protocols. The instructions may be stored in the form of the computer program 1000. In some examples, the processor or processing circuitry 1002 may include one or more microprocessors or microcontrollers, as well as other digital hardware, which may include digital signal processors (DSPs), special-purpose digital logic, etc. The processor or processing circuitry 1002 may be implemented by any type of integrated circuit, such as an Application Specific Integrated Circuit (ASIC), Field Programmable Gate Array (FPGA) etc. The memory 1004 may include one or several types of memory suitable for the processor, such as read-only memory (ROM), random-access memory, cache memory, flash memory devices, optical storage devices, solid state disk, hard disk drive etc.

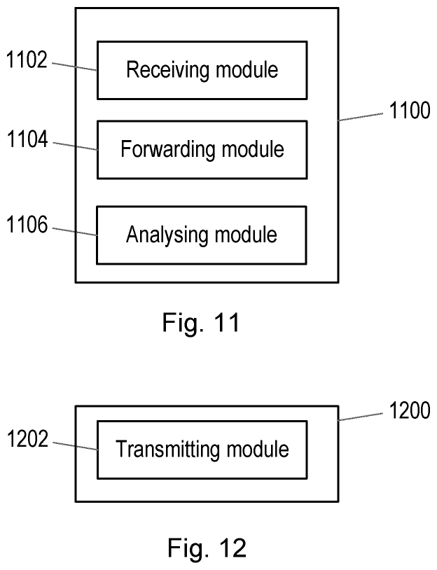

FIG. 11 is a block diagram showing an alternative first wireless device 1100. The first wireless device 1100 is for communicating with a cellular communication network via a second wireless device operating as a relay UE. The first wireless device 1100 is operating as a remote UE according to an embodiment of the disclosure. As shown, the first wireless device 1100 comprises a receiving module 1102, a forwarding module 1104, and an analysing module 1106. The receiving module 1102 may be configured to receive radio link information from the relay UE, with the radio link information relating to a cellular radio link between the relay UE and a base station in the cellular communication network. The forwarding module 1104 may be configured to forward the received radio link information to an upper layer of the first wireless device. The analysing module 1106 may be configured to analyse, in the upper layer, the received radio link information to determine a status of the cellular radio link. The modules described above may be implemented by hardware, or software, or a combination of both.

FIG. 12 is a block diagram showing an alternative second wireless device 1200. The second wireless device 1200 is for enabling communication between a cellular communication network and a first wireless device operating as a remote UE. Thus the second wireless device 1200 is operating as a relay UE according to an embodiment of the disclosure. As shown, the second wireless device 1200 comprises a transmitting module 1202. The transmitting module 1102 may be configured to transmit radio link information to the remote UE, with the radio link information relating to a cellular radio link between the second wireless device and a base station in the cellular communication network. The modules described above may be implemented by hardware, or software, or a combination of both.

Examples of the present disclosure thus provide methods for operating a first wireless device, where the first wireless device is communicating with a cellular communication network via a second wireless device operating as a relay UE, and for operating a second wireless device, where the second wireless device is enabling communication between a cellular communication network and a first wireless device operating as a remote UE, that enable an upper layer of a first wireless device operating as a remote UE to receive radio link information, and that further enable the received radio link information to be analysed at the upper layer in order to determine a status of a cellular radio link. It will be appreciated that execution of the aforementioned methods may result in reduced latency for delay sensitive transmissions to the first wireless device operating as a remote UE. Additionally, execution of the aforementioned methods may mitigate service interruptions as a result of RLF on a cellular link. Additionally, execution of the aforementioned methods may allow RLF indicators of a cellular link to be transmitted to a first wireless device operating as a remote UE, such that the first wireless device operating as a remote UE may be informed of the cellular link RLF in time.

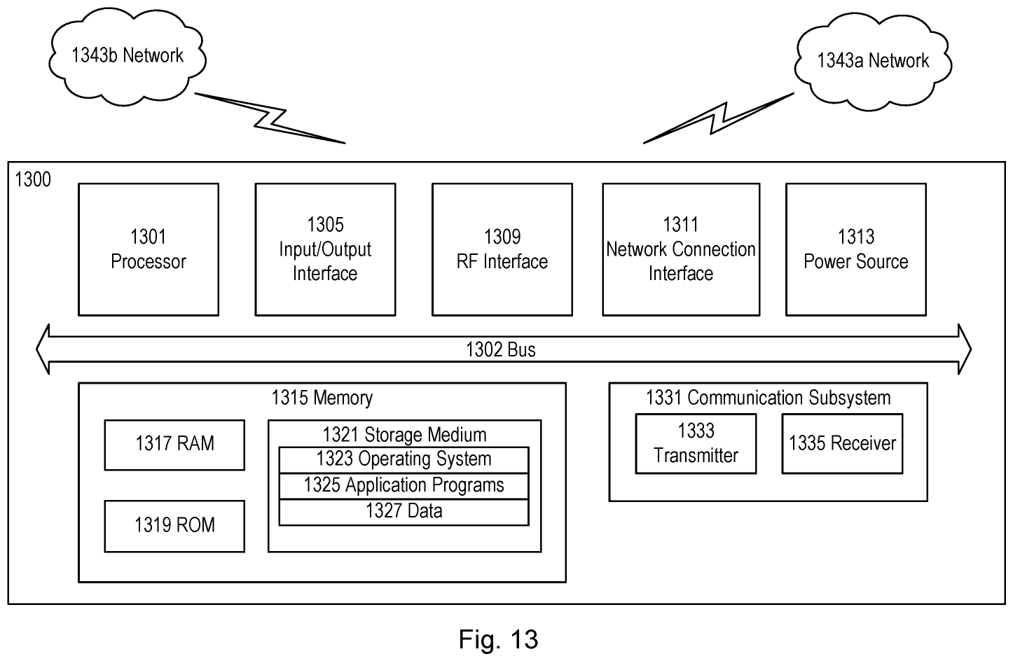

FIG. 13 illustrates one embodiment of a wireless device (WD)/UE in accordance with various aspects described herein. The first wireless device and/or the second wireless device can be implemented as shown in FIG. 13. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1300 may be any UE identified by the 3rd Generation Partnership Project (3GPP), including a NB-IoT UE, a machine type communication (MTC) UE, and/or an enhanced MTC (eMTC) UE. UE 1300, as illustrated in FIG. 13, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 13 is a UE, the components discussed herein are equally applicable to a WD, and vice-versa.

In FIG. 13, UE 1300 includes processing circuitry 1301 that is operatively coupled to input/output interface 1305, radio frequency (RF) interface 1309, network connection interface 1311, memory 1315 including random access memory (RAM) 1317, read-only memory (ROM) 1319, and storage medium 1321 or the like, communication subsystem 1331, power source 1333, and/or any other component, or any combination thereof. Storage medium 1321 includes operating system 1323, application program 1325, and data 1327. In other embodiments, storage medium 1321 may include other similar types of information. Certain UEs may utilize all of the components shown in FIG. 13, or only a subset of the components. The level of integration between the components may vary from one UE to another UE. Further, certain UEs may contain multiple instances of a component, such as multiple processors, memories, transceivers, transmitters, receivers, etc.

In FIG. 13, processing circuitry 1301 may be configured to process computer instructions and data. Processing circuitry 1301 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1301 may include two central processing units (CPUs). Data may be information in a form suitable for use by a computer.

In the depicted embodiment, input/output interface 1305 may be configured to provide a communication interface to an input device, output device, or input and output device. UE 1300 may be configured to use an output device via input/output interface 1305. An output device may use the same type of interface port as an input device. For example, a USB port may be used to provide input to and output from UE 1300. The output device may be a speaker, a sound card, a video card, a display, a monitor, a printer, an actuator, an emitter, a smartcard, another output device, or any combination thereof. UE 1300 may be configured to use an input device via input/output interface 1305 to allow a user to capture information into UE 1300. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 13, RF interface 1309 may be configured to provide a communication interface to RF components such as a transmitter, a receiver, and an antenna. Network connection interface 1311 may be configured to provide a communication interface to network 1343a. Network 1343a may encompass wired and/or wireless networks such as a local-area network (LAN), a wide-area network (WAN), a computer network, a wireless network, a telecommunications network, another like network or any combination thereof. For example, network 1343a may comprise a Wi-Fi network.

Network connection interface 1311 may be configured to include a receiver and a transmitter interface used to communicate with one or more other devices over a communication network according to one or more communication protocols, such as Ethernet, TCP/IP, SONET, ATM, or the like. Network connection interface 1311 may implement receiver and transmitter functionality appropriate to the communication network links (e.g., optical, electrical, and the like). The transmitter and receiver functions may share circuit components, software or firmware, or alternatively may be implemented separately.

RAM 1317 may be configured to interface via bus 1302 to processing circuitry 1301 to provide storage or caching of data or computer instructions during the execution of software programs such as the operating system, application programs, and device drivers. ROM 1319 may be configured to provide computer instructions or data to processing circuitry 1301. For example, ROM 1319 may be configured to store invariant low-level system code or data for basic system functions such as basic input and output (I/O), startup, or reception of keystrokes from a keyboard that are stored in a non-volatile memory. Storage medium 1321 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1321 may be configured to include operating system 1323, application program 1325 such as a web browser application, a widget or gadget engine or another application, and data file 1327. Storage medium 1321 may store, for use by UE 1300, any of a variety of various operating systems or combinations of operating systems.

Storage medium 1321 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1321 may allow UE 1300 to access computer-executable instructions, application programs or the like, stored on transitory or non-transitory memory media, to off-load data, or to upload data. An article of manufacture, such as one utilizing a communication system may be tangibly embodied in storage medium 1321, which may comprise a device readable medium.

In FIG. 13, processing circuitry 1301 may be configured to communicate with network 1343b using communication subsystem 1331. Network 1343a and network 1343b may be the same network or networks or different network or networks. Communication subsystem 1331 may be configured to include one or more transceivers used to communicate with network 1343b. For example, communication subsystem 1331 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1333 and/or receiver 1335 to implement transmitter or receiver functionality, respectively, appropriate to the RAN links (e.g., frequency allocations and the like). Further, transmitter 1333 and receiver 1335 of each transceiver may share circuit components, software or firmware, or alternatively may be implemented separately.

In the illustrated embodiment, the communication functions of communication subsystem 1331 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1331 may include cellular communication, Wi-Fi communication, Bluetooth communication, and GPS communication. Network 1343b may encompass wired and/or wireless networks such as a local-area network (LAN), a wide-area network (WAN), a computer network, a wireless network, a telecommunications network, another like network or any combination thereof. For example, network 1343b may be a cellular network, a Wi-Fi network, and/or a near-field network. Power source 1313 may be configured to provide alternating current (AC) or direct current (DC) power to components of UE 1300.

The features, benefits and/or functions described herein may be implemented in one of the components of UE 1300 or partitioned across multiple components of UE 1300. Further, the features, benefits, and/or functions described herein may be implemented in any combination of hardware, software or firmware. In one example, communication subsystem 1331 may be configured to include any of the components described herein. Further, processing circuitry 1301 may be configured to communicate with any of such components over bus 1302. In another example, any of such components may be represented by program instructions stored in memory that when executed by processing circuitry 1301 perform the corresponding functions described herein. In another example, the functionality of any of such components may be partitioned between processing circuitry 1301 and communication subsystem 1331. In another example, the non-computationally intensive functions of any of such components may be implemented in software or firmware and the computationally intensive functions may be implemented in hardware.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method of operating a first wireless device, wherein the first wireless device is communicating with a cellular communication network via a second wireless device operating as a relay UE, the method comprising:
receiving radio link information from the relay UE, wherein the radio link information relates to a cellular radio link between the relay UE and a base station in the cellular communication network;
forwarding the received radio link information to an upper layer of the first wireless device; and
analyzing, in the upper layer, the received radio link information to determine a status of the cellular radio link; and
wherein the step of receiving comprises receiving the radio link information from the relay UE at an adaptation layer of the first wireless device.

2. A method according to claim 1, wherein the upper layer comprises a radio resource control RRC, layer.

3. A method according to claim 1, wherein the radio link information comprises one or more of: radio link monitoring, RLM, information, a failure indication relating to the cellular radio link, an impending failure indication relating to the cellular radio link, a radio link failure, RLF, event indicator, an out of sync indicator, an in sync indicator, a radio link control, RLC, failure indicator, a number of uplink RLC retransmissions on the cellular radio link, a random access channel, RACH, failure indicator, a number of random access transmission attempts on the cellular radio link, an indication of whether a number of random access transmission attempts on the cellular radio link has reached a maximum number of attempts, a radio link identifier, and a failure cause.

4. A method according to claim 1, wherein the radio link information relates to a RRC connection of the relay UE to the base station.

5.-14. (canceled)

15. A method of operating a second wireless device, wherein the second wireless device is enabling communication between a cellular communication network and a first wireless device operating as a remote UE, the method comprising:
transmitting radio link information to the remote UE, wherein the radio link information relates to a cellular radio link between the second wireless device and a base station in the cellular communication network; and
wherein the step of transmitting the radio link information to the remote UE comprises transmitting the radio link information to the remote UE via an adaptation layer of the second wireless device.

16.-28. (canceled)

29. A first wireless device configured to communicate with a cellular communication network via a second wireless device operating as a relay UE, the first wireless device configured to:
receive radio link information from the relay UE, wherein the radio link information relates to a cellular radio link between the relay UE and a base station in the cellular communication network;
forward the received radio link information to an upper layer of the first wireless device; and
analyze, in the upper layer, the received radio link information to determine a status of the cellular radio link; and
wherein the first wireless device is configured to receive the radio link information from the relay UE at an adaptation layer of the first wireless device.

30. A first wireless device according to claim 29, wherein the upper layer comprises a radio resource control RRC, layer.

31. A first wireless device according to claim 29, wherein the radio link information comprises one or more of: radio link monitoring, RLM, information, a failure indication relating to the cellular radio link, an impending failure indication relating to the cellular radio link, a radio link failure, RLF, event indicator, an out of sync indicator, an in sync indicator, a radio link control, RLC, failure indicator, a number of uplink RLC retransmissions on the cellular radio link, a random access channel, RACH, failure indicator, a number of random access transmission attempts on the cellular radio link, an indication of whether a number of random access transmission attempts on the cellular radio link has reached a maximum number of attempts, a radio link identifier, and a failure cause.

32. A first wireless device according to claim 29, wherein the radio link information relates to a RRC connection of the relay UE to the base station.

33.-35. (canceled)

36. A first wireless device according to claim 29, wherein the status of the cellular radio link is an indication of whether a failure of the cellular radio link has occurred.

37. A first wireless device according to claim 29, wherein the first wireless device is further configured to:
determine an action to perform based on the determined status of the cellular radio link; and
perform the action.

38. A first wireless device according to claim 37, wherein the action comprises one or more of:
(i) declaring a radio link failure, RLF, event for the cellular radio link,
(ii) releasing a PC5 connection with the relay UE,
(iii) informing the relay UE to release a PC5 connection with the first wireless device,
(iv) informing the relay UE to release a Radio Link Control, RLC, layer connection, a Medium Access Control, MAC, layer connection and/or a Physical, PHY, layer connection,
(v) maintaining a RRC connection at the first wireless device towards the cellular communication network,
(vi) maintaining radio bearers at the first wireless device towards the cellular communication network,
(vii) maintaining Packet Data Convergence Protocol, PDCP, entities at the first wireless device towards the cellular communication network.

39. A first wireless device according to claim 37, wherein the action further comprises:
initiating a discovery procedure to identify a further relay UE that a connection may be established with.

40. A first wireless device according to claim 39, wherein the first wireless device is further configured to:
establish a connection with the further relay UE.

41. A first wireless device as claimed in claim 29, wherein the relay UE has a plurality of cellular radio links to the cellular communication network, and wherein the received radio link information relates to any one or more of the plurality of cellular radio links.

42. A first wireless device according to claim 29, wherein the first wireless device and the relay UE are connected via Long Term Evolution, LTE, or 5G sidelink, or via a short-range communication technology.

43. A second wireless device configured for enabling communication between a cellular communication network and a first wireless device operating as a remote UE, the second wireless device configured to:
transmit radio link information to the remote UE, wherein the radio link information relates to a cellular radio link between the second wireless device and a base station in the cellular communication network; and
wherein the second wireless device is configured to transmit the radio link information to the remote UE via an adaptation layer of the second wireless device.

44. A second wireless device according to claim 43, wherein the radio link information comprises one or more of: radio link monitoring, RLM, information, a failure indication relating to the cellular radio link, an impending failure indication relating to the cellular radio link, a radio link failure, RLF, event indicator, an out of sync indicator, an in sync indicator, a radio link control, RLC, failure indicator, a number of uplink RLC retransmissions on the cellular radio link, a random access channel, RACH, failure indicator, a number of random access transmission attempts on the cellular radio link, an indication of whether a number of random access transmission attempts on the cellular radio link has reached a maximum number of attempts, a radio link identifier, and a failure cause.

45. A second wireless device according to claim 43, wherein the radio link information relates to a RRC connection of the second wireless device to the base station.

46.-48. (canceled)

49. A second wireless device as claimed in claim 43, wherein the second wireless device is further configured to:
determine whether a failure of the cellular radio link has occurred; and
wherein the radio link information indicates whether a failure of the cellular radio link has occurred.

50. A second wireless device as claimed in claim 49, wherein the second wireless device is configured to determine whether a failure of the cellular radio link has occurred in one of: a radio link control, RLC, layer of the second wireless device, a medium access control, MAC, layer of the second wireless device, and a physical, PHY, layer of the second wireless device.

51. A second wireless device according to claim 43, wherein the second wireless device is configured to enable communication between the cellular communication network and a plurality of first wireless devices each operating as a remote UE, wherein the second wireless device is further configured to:
unicast the radio link information to one or more of the remote UEs.

52. A second wireless device according to claim 43, wherein the second wireless device is configured to enable communication between the cellular communication network and a plurality of first wireless devices each operating as a remote UE, and the second wireless device is further configured to:
groupcast the radio link information to the remote UEs.

53. A second wireless device as claimed in claim 43, wherein the second wireless device is further configured to one or more of:
(iv) release a PC5 connection with the remote UE,
(v) receiving an instruction from the remote UE to release a PC5 connection with the remote UE, and
(vi) receiving an instruction from the remote UE to release a Radio Link Control, RLC, layer, a Medium Access Control, MAC, layer and/or a Physical, PHY, layer towards the cellular communication network.

54. A second wireless device as claimed in claim 43, wherein the second wireless device is configured to have a plurality of cellular radio links to the cellular communication network, and wherein the transmitted radio link information relates to any one or more of the plurality of cellular radio links.

55. A second wireless device according to claim 43, wherein the second wireless device and the remote UE are connected via Long Term Evolution, LTE, or 5G sidelink, or via a short range communication technology.
